(19) United States
(12) Patent Application Publication
(10) Pub. No.: US 2011/0156445 A1
(43) Pub. Date: Jun. 30, 2011

(54) MOTOR VEHICLE FEATURING A STRUCTURAL CAR BODY COLUMN WITH A STRUCTURAL COMPONENT AND METHOD FOR CONNECTING A STRUCTURAL COMPONENT OF A STRUCTURAL CAR BODY COLUMN

(75) Inventors: Klaus LABBE, Undenheim (DE); Juergen HULBERT, Eltville (DE)

(73) Assignee: GM GLOBAL TECHNOLOGY OPERATIONS LLC, Detroit, MI (US)

(21) Appl. No.: 12/975,034

(22) Filed: Dec. 21, 2010

(30) Foreign Application Priority Data
Dec. 21, 2009 (DE) 102009059825.1

(51) Int. Cl. B62D 25/04; B23K 31/02; B23K 9/00; B23K 26/00

(52) U.S. Cl. 296/193.06; 228/101; 228/141.1; 219/137 R; 219/121.64

(57) ABSTRACT

A motor vehicle is provided that includes, but is not limited to a structural car body column with a structural component. The structural component is realized in the form of a closed hollow profile and features at least one recess. The structural component is connected to at least one region of the car body of the motor vehicle that adjoins the structural car body column by means of at least one welding seam. The at least one welding seam is arranged on the opposite side of the structural component referred to the at least one recess.

### CROSS-REFERENCE TO RELATED APPLICATION

This application claims priority to German Patent Application No. 102009059825.1, filed Dec. 21, 2009, which is incorporated herein by reference in its entirety.

### TECHNICAL FIELD

The technical field pertains to a motor vehicle that features a structural car body column with a structural component and to a method for connecting a structural component of a structural car body column of a motor vehicle to at least one region of the car body of the motor vehicle that adjoins the structural car body column.

### BACKGROUND

DE 10 2007 014 116 A1 discloses a column, particularly an A-column, that forms part of a car body structure of a motor vehicle. The A-column has a hollow profile with a closed cross section. In order to simplify the incorporation of the A-column into the car body structure, it is proposed that the end section of the respective hollow profile to be connected to the car body structure is rigidly connected to a corresponding sheet metal connector, and that the sheet metal connector can be connected to the car body structure.

DE 10 2005 016 993 A1 discloses a passenger compartment for passenger cars. The passenger compartment comprises an A-column that extends laterally of the windshield up to a roof joint of a B-column in the central region of the vehicle side and consists of a hydro formed profile. In order to provide the A-column of small cross section in this passenger compartment with a high strength and rigidity in a cost-efficient and low-weight fashion while still allowing a technologically simple connection to other car body parts, the A-column features integral weldable connecting elements for being welded to other car body parts.

In view of the foregoing, it is the objective to additionally develop a structural car body column with a structural component that has the cross section of a closed hollow profile in such a way that time-consuming and costly connecting processes for connecting the structural car body column to the car body of a motor vehicle are not required. It should simultaneously be possible to utilize a manufacturing or connecting method that makes it possible to observe required dimensional accuracies, particularly for the structural car body column, due to the least heat development possible. In addition, other objectives, desirable features and characteristics will become apparent from the subsequent summary detailed description, and the appended claims, taken in conjunction with the accompanying drawings and this background.

### SUMMARY

A motor vehicle is provided that features a structural car body column with a structural component. The structural component is realized in the form of a closed hollow profile. The structural component features at least one recess and is connected to at least one region of the car body of the motor vehicle that adjoins the structural car body column by means of at least one welding seam. The at least one welding seam is arranged on the opposite side of the structural component referred to the at least one recess.

Due to the fact that the structural component features at least one recess, access for connecting the structural component to the car body structure can be provided on one side at this location. This access therefore makes it possible to connect the structural component to the at least one region of the car body of the motor vehicle that adjoins the structural car body column by means of the at least one welding seam. Consequently, the structural component can be advantageously realized in the form of a closed hollow profile without additional welding flange. This eliminates time-consuming and costly connecting processes for connecting the structural car body column to the car body. This furthermore improves the arrangement with respect to weight, flexibility and costs. The structural component may feature aluminum and/or steel and/or a plastic.

In an embodiment, the structural car body column forms an A-column of the motor vehicle. It would furthermore be possible that the structural car body column forms a C-column or a D-column of the motor vehicle.

The at least one recess may be realized in the form of an ellipsoidal, particularly circular, material recess or a rectangular, particularly square, material recess. The at least one recess may furthermore be realized in the form of an angular cut on an end region of the structural component. In case the structural component features several recesses, it is also possible to utilize a combination of the aforementioned embodiments. The at least one welding seam may be realized in a punctiform or linear fashion. In case the structural component is connected to the at least one region of the car body of the motor vehicle that adjoins the structural car body column by means of several welding seams, it is also possible to utilize a combination of the two aforementioned forms of welding seams.

In another embodiment, the at least one region that adjoins the structural car body column is a sheet metal reinforcement of a lateral roof corner or a lateral roof frame of the motor vehicle. In addition, the at least one region that adjoins the structural car body column may be a sheet metal reinforcement of a B-column of the motor vehicle. In this case, it is particularly preferred that the structural component is connected to the sheet metal reinforcement of the lateral roof corner or lateral roof frame of the motor vehicle and to the sheet metal reinforcement of the B-column of the motor vehicle. In one embodiment, the structural component is connected to both sheet metal reinforcements by means of at least one common welding seam.

In this case, the structural component preferably extends essentially in a longitudinal direction of the motor vehicle and is realized in one piece. A first side of the structural component may provide a support surface for a window of the motor vehicle in this case. In addition, the structural car body column may feature a cover. The cover features an elastic material and is arranged on the structural component in the direction of an outer side of the motor vehicle. It is furthermore preferred that the cover can be painted such that an adaptation to different designs can be advantageously achieved and the number of degrees of freedom with respect to the design of the structural car body column such as, for example, the optical design is increased.

A method is provided for connecting a structural component of a structural car body column of a motor vehicle to at least one region of the car body of the motor vehicle that adjoins the structural car body column. The method features the following steps: providing the structural component. The structural component is realized in the form of a closed hollow profile, and wherein the structural component features at least one recess. The structural component is then welded to the at least one region of the car body of the motor vehicle that adjoins the structural car body column such that at least one welding seam is produced and the at least one welding seam is arranged on the opposite side of the structural component referred to the at least one recess. The method provides the advantages that were already described above in connection with the inventive motor vehicle and are not reiterated at this point in order to avoid repetitions.

In this case, the structural car body column preferably is an A-column of the motor vehicle. It would furthermore be possible that the structural car body column forms a C-column or a D-column of the motor vehicle.

The welding of the structural component to the at least one region of the car body that adjoins the structural car body column can be realized by means of electrode welding or resistance welding, particularly spot welding, and/or by means of the laser welding, particularly CO2 laser welding. This means that an advantageous manufacturing process with little heat development is utilized such that the required dimensional accuracies, particularly of the structural car body column and of the structural component, can be advantageously observed.

The at least one recess can already be produced in the structural component during the manufacturing process of the structural component. In one embodiment, the at least one recess is produced in the structural component by means of hydro forming. It is furthermore possible to produce the at least one recess in the structural components by means of subsequent manufacturing processes.

In one embodiment, the at least one recess is produced in the structural component by means of laser cutting. In case the structural component features several recesses, it is also possible to utilize a combination of the aforementioned embodiments. The at least one recess may be realized in the form of an ellipsoidal, particularly circular, material recess or a rectangular, particularly square, material recess. The at least one recess may furthermore be realized in the form of an angular cut on an end region of the structural component. In case the structural component features several recesses, it is also possible to utilize a combination of the aforementioned embodiments.

The at least one welding seam may be realized in a punctiform or linear fashion. In case the structural component is welded to the at least one region of the car body of the motor vehicle that adjoins the structural car body column by means of several welding seams, it is also possible to utilize a combination of the two embodiments.

In one embodiment, the at least one region that adjoins the structural car body column is a sheet metal reinforcement of a lateral roof corner or a lateral roof frame of the motor vehicle. In another embodiment, the at least one region that adjoins the structural car body column is a sheet metal reinforcement of a B-column of the motor vehicle.

In one particularly preferred embodiment, the structural component is welded to the sheet metal reinforcement of the lateral roof corner or lateral roof channel of the motor vehicle, as well as to the sheet metal reinforcement of the B-column of the motor vehicle. In this case, the welding may be realized such that at least one common welding seam is produced between the structural component, the sheet metal reinforcement of the lateral roof corner or lateral roof frame and the sheet metal reinforcement of the B-column.

The structural component is preferably realized in one piece and essentially arranged in a longitudinal direction of the motor vehicle in one embodiment. In this case, a first side of the structural component may provide a support surface for a window of the motor vehicle.

### BRIEF DESCRIPTION OF THE DRAWINGS

The present invention will hereinafter be described in conjunction with the following drawing figures, wherein like numerals denote like elements, and.

FIG. 1 shows a schematic perspective representation of a section of a motor vehicle according to one embodiment;

FIG. 2 shows a schematic perspective representation of another section of the motor vehicle according to FIG. 1;

FIG. 3 shows a schematic perspective representation of a section of a motor vehicle according to another embodiment;

FIG. 4A shows a cross section along the line A-A in FIG. 2;

FIG. 4B shows a cross section along the line B-B in FIG. 2;

FIG. 4C shows a cross section along the line C-C in FIG. 2, and

FIG. 4D shows a cross section along the line D-D in FIG. 2.

### DETAILED DESCRIPTION

The following detailed description is merely exemplary in nature and is not intended to limit application and uses. Furthermore, there is no intention to be bound by any theory presented in the preceding background or summary or the following detailed description.

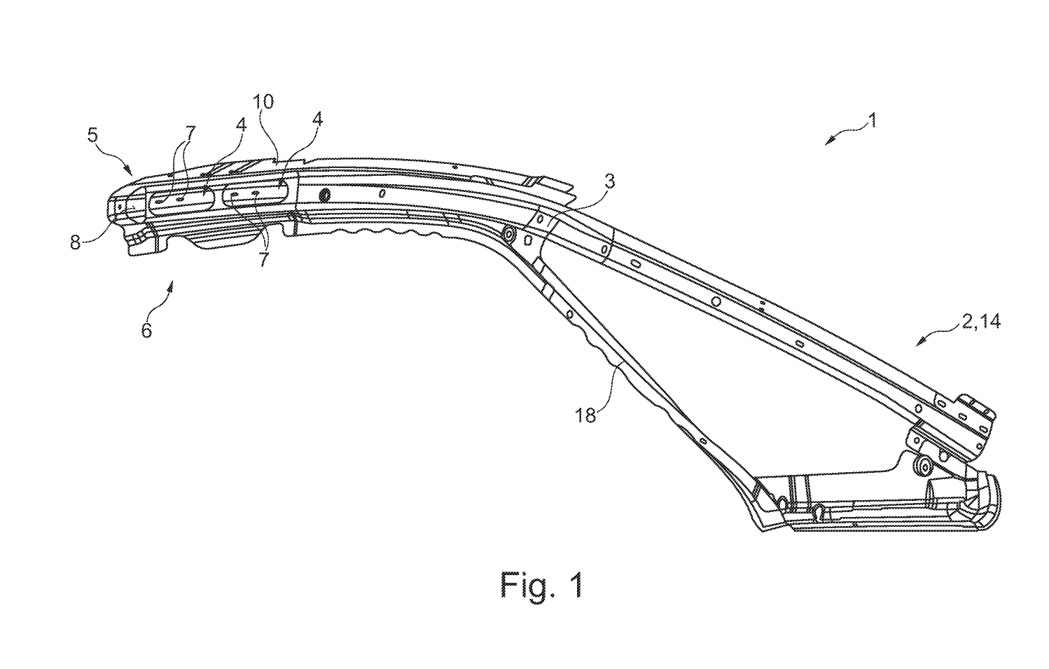

FIG. 1 shows a schematic perspective representation of a section of a motor vehicle 1 in the form of a passenger car according to one embodiment. The motor vehicle 1 features a structural car body column 2 with a structural component 3. The structural component 3 is realized in the form of a closed, one-piece hollow profile. In the embodiment shown, the structural component 3 essentially extends laterally of a not-shown windshield in a longitudinal direction of the motor vehicle 1, namely from an also not-shown outer front side wall section to a front roof joint and then to a central roof joint. In this case, the front roof joint designates the region of the structural car body column 2 on the roof side, up to which the windshield extends, and the central roof joint designates the end of an also not-shown B-column of the motor vehicle 1 on the roof side.

In the embodiment shown, the structural car body column 2 is an A-column 14 that is also referred to as A1-column in order to be distinguished from an A2-column 18 of the motor vehicle 1. The structural component 3 of the structural car body column 2 is connected to at least one region 5 of the car body 6 of the motor vehicle 1 that adjoins the structural car body column 2. For this purpose, the structural component 3 is connected to a sheet metal reinforcement 10 of a lateral roof corner or roof frame of the motor vehicle 1 by means of welding seams 7 in the embodiment shown. The welding seams 7 may be realized in a punctiform and/or linear fashion.

The structural component 3 furthermore features recesses 4 on a first side. The welding seams 7 are arranged on a second side 8 of the structural component 3 that lies opposite of the first side or the recesses 4, respectively. In the embodiment shown, the recesses 4 are essentially realized in the form of ellipsoidal material recesses. The recesses 4 may also be realized in the form of rectangular material recesses. In addition, it is also possible to utilize a combination of the two aforementioned shapes.

In the embodiment shown, the structural component 3 features two recesses 4. However, it would also be possible that the structural component 3 only features one recess 4 or more than two recesses 4. In addition, it would also be possible that only one welding seam 7 is provided. One side of the structural component 3 may provide a support surface for the windshield of the motor vehicle 1.

The structural car body column 2 may furthermore feature a cover. The cover features an elastic material and is arranged on the structural component 3 in the direction of an outer side of the motor vehicle 1. In this case, it is preferred that the cover can be painted.

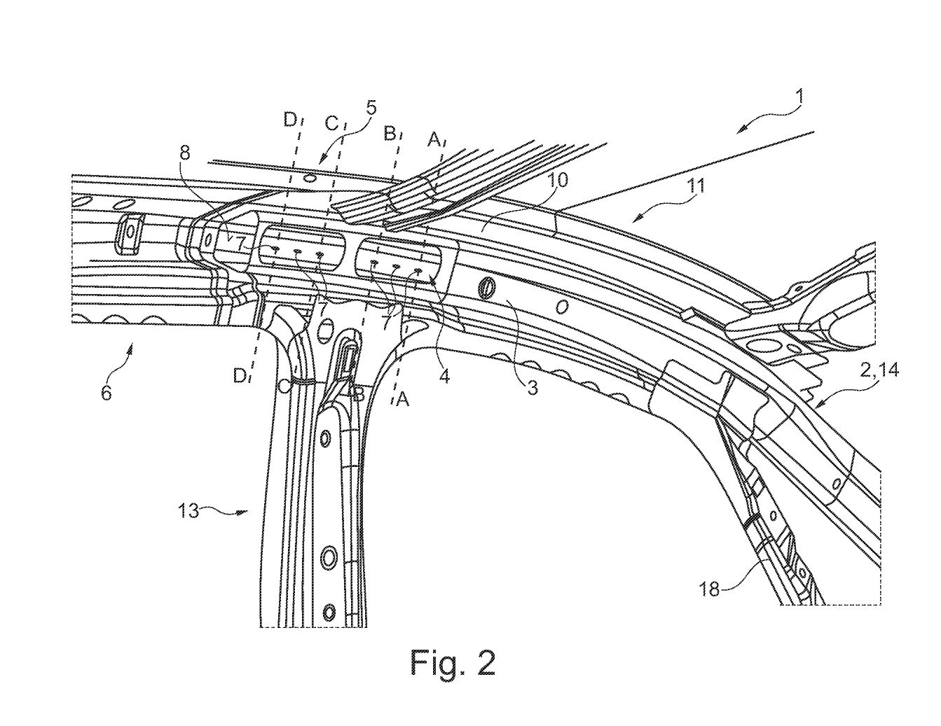

FIG. 2 shows a schematic perspective representation of another section of the motor vehicle 1 according to FIG. 1. Components with the same functions as in FIG. 1 are identified by the same reference symbols and not elucidated in greater detail below. FIG. 2 shows the rear end of the structural component 3 in greater detail. According to FIG. 2, the structural component 3 extends up to a central roof joint, i.e., into the region of the end of a B-column 13 of the motor vehicle 1 on the roof side.

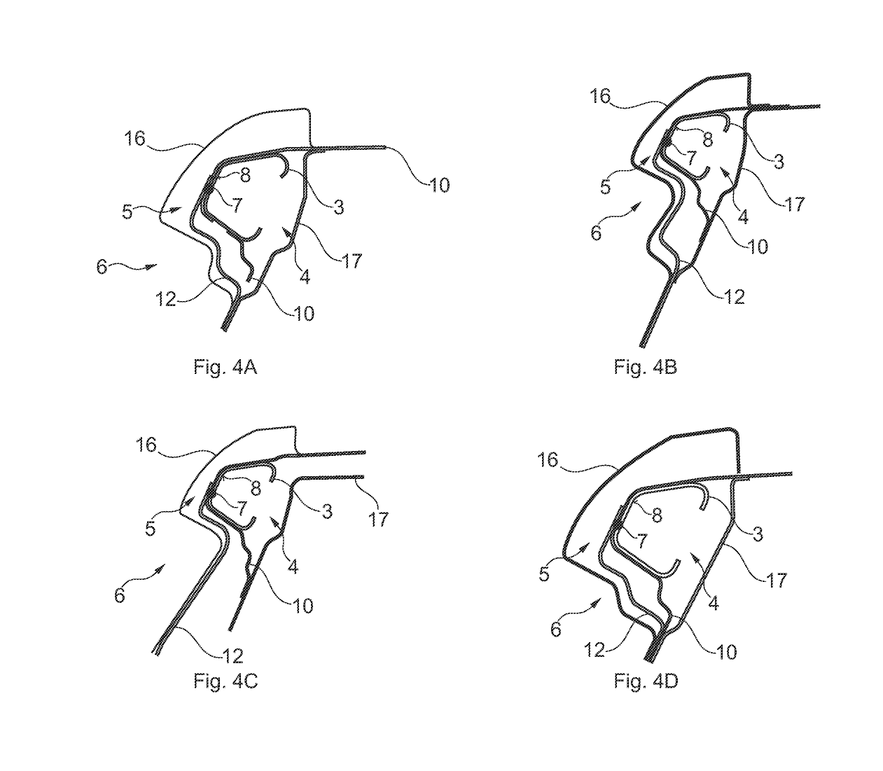

As already explained above in connection with FIG. 1, the structural component 3 is connected to the region 5 of the car body 6 of the motor vehicle 1 that adjoins the structural car body column 2 by means of the welding seams 7. To this end, the structural component 3 is connected to the sheet metal reinforcement 10 of a lateral roof frame or roof corner 11 of the motor vehicle 1, as well as to a sheet metal reinforcement of the B-column 13, by means of the welding seams 7. This is elucidated in greater detail below with reference to FIG. 4A to FIG. 4D.

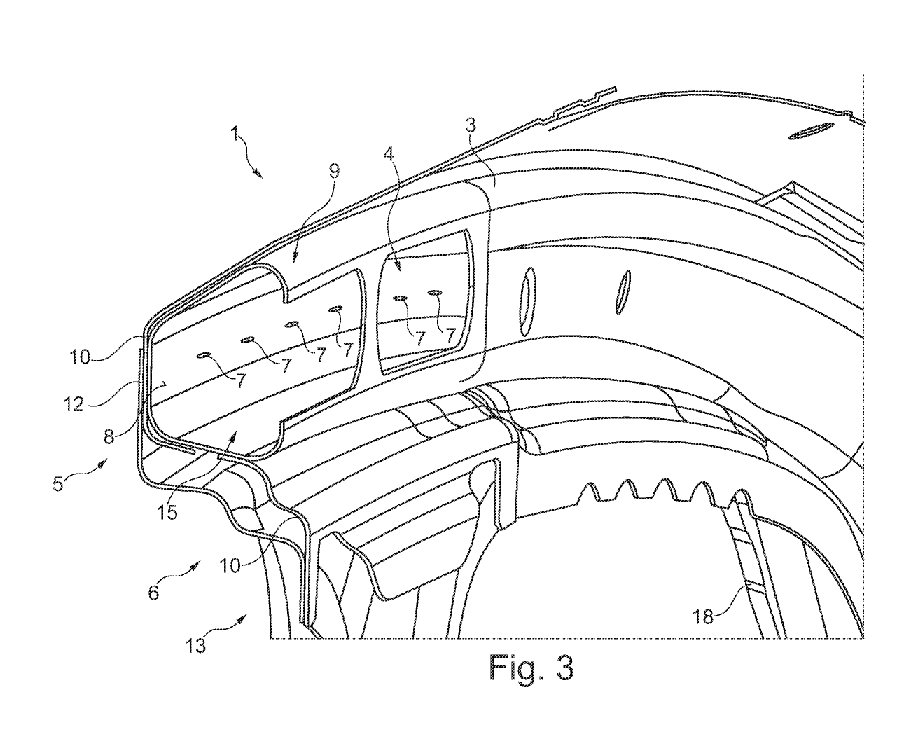

FIG. 3 shows a schematic perspective representation of a section of a motor vehicle 1 in the form of a passenger car according to another embodiment. Components with the same functions as in the preceding figures are identified by the same reference symbols and not elucidated in greater detail below. In this embodiment, the structural component 3 features a recess 4, as well as a recess 15. The recess 4 is realized in the form of an essentially ellipsoidal material recess. The recess 15 is situated in an end region 9 of the structural component 3 that represents the rear end of the structural component 3. In this case, the recess 15 originates at the rear end of the structural component 3.

In a not-shown embodiment, the recess 15 may also be realized in the form of an angular cut on the end region 9 of the structural component 3. According to FIG. 3, the structural component 3 is connected to the sheet metal reinforcement 10 of the lateral roof corner or roof frame, as well as to the sheet metal reinforcement 12 of the B-column 13, by means of the welding seams 7.

In this case, a method for connecting the structural component 3 of the structural car body column 2 of the motor vehicle 1 to the at least one region 5 of the car body 6 of the motor vehicle 1 that adjoins the structural car body column 2 may feature the following steps for the embodiments illustrated in FIG. 1 to FIG. 3. Initially, the structural component 3 is provided. The structural component 3 is realized in the form of a closed hollow profile and features at least one recess 4 and/or 15. The recesses 4 and 15 may either be produced during the manufacture of the structural component 3, for example, by means of hydro forming, or with subsequent manufacturing processes such as, for example, laser welding, namely in the form of material recesses at the locations, at which access is subsequently required on one side in order to produce the connection with the car body structure, for example, by means of spot welding. This access may also be provided, for example, on the ends of the structural component 3 by producing an angular cut during the manufacturing process of the hollow profile in the form of the structural component 3 or subsequently.

The structural component 3 is furthermore welded to the at least one region 5 of the car body 6 that adjoins the structural car body column 2 such that the welding seams 7 are produced, wherein the welding seams 7 are arranged on the opposite side 8 of the structural component 3 referred to the at least one recess 4 or 15. In this case, the welding of the structural component 3 to the at least one region of the car body 6 that adjoins the structural car body column 2 may be realized by means of electrode welding, particularly spot welding, and/or by means of laser welding, particularly CO2 laser welding. In the embodiments according to FIG. 1 to FIG. 3, the structural component 3 is welded to the sheet metal reinforcement 10 of the lateral roof frame or roof corner 11, as well as to the sheet metal reinforcement 12 of the B-column 13, by means of the welding seams 7.

FIG. 4A to FIG. 4D respectively show cross sections through the motor vehicle 1 illustrated in FIG. 2. FIG. 4A shows a cross section along the line A-A, FIG. 4B shows a cross section along the line B-B, FIG. 4C shows a cross section along the line C-C and FIG. 4D shows a cross section along the line D-D. Components with the same functions as in the preceding figures are identified by the same reference symbols and not elucidated in greater detail below.

According to FIG. 4A to FIG. 4D, the structural component 3 is connected to the sheet metal reinforcement 10 of the lateral roof corner or roof frame and to the sheet metal reinforcement 12 of the B-column by means of three-layered spot welds or welding seams 7. FIG. 4A to FIG. 4D furthermore shows an outer side wall 16 and an inner side wall 17 of the motor vehicle.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A motor vehicle including a car body, comprising:
a structural car body column; and
a structural component of the structural car body column, the structural component comprising:
a closed hollow profile; and
a recess connected to a region of the car body adjoining the structural car body column with a welding seam, wherein the welding seam is arranged on an opposite side of the structural component referred to the recess.

2. The motor vehicle according to claim 1, wherein the structural car body column is an A-column.

3. The motor vehicle according to claim 1, wherein the recess is an ellipsoidal recess.

4. The motor vehicle according to claim 1, wherein the recess is a rectangular recess.

5. The motor vehicle according to claim 1, wherein the recess is an angular cut on an end region of the structural component.

6. The motor vehicle according to claim 1, wherein the region adjoining the structural car body column is a sheet metal reinforcement of a lateral roof corner of the motor vehicle.

7. The motor vehicle according to claim 1, wherein the region adjoining the structural car body column is a sheet metal reinforcement of a B-column of the motor vehicle.

8. A method for connecting a structural component of a structural car body column of a motor vehicle to a region of a car body of the motor vehicle that adjoins the structural car body column, comprising:
providing the structural component in a form of a closed hollow profile and a recess as a feature of the structural component;
welding the structural component to the region of the car body that adjoins the structural car body column to produce a welding seam; and
arranging the welding seam on an opposite side of the structural component referred to the recess (4, 15).

9. The method according to claim 8, wherein the welding the structural component to the region of the car body that adjoins the structural car body column comprises electrode welding.

10. The method according to claim 8, wherein welding the structural component to the region of the car body that adjoins the structural car body column comprises laser welding.

11. The method according to claim 8, further comprising hydro forming the recess (4) in the structural component.

12. The method according to claim 8, further comprising laser cutting the recess in the structural component.

13. The method according to claim 8, wherein the recess is an ellipsoidal recess.

14. The method according to claim 8, wherein the recess is a rectangular material recess.

15. The method according to claim 8, wherein the recess is an angular cut on an end region of the structural component.

16. The method according to claim 8, wherein the region that adjoins the structural car body column is a sheet metal reinforcement of a lateral roof corner of the motor vehicle.

17. The method according to claim 8, wherein the region that adjoins the structural car body column is a sheet metal reinforcement of a B-column of the motor vehicle.
